(19) United States
(12) Patent Application Publication
(10) Pub. No.: US 2016/0071098 A1
(43) Pub. Date: Mar. 10, 2016

(54) SYSTEMS AND METHODS FOR PERFORMING SECURE TRANSACTIONS THROUGH AN INTERMEDIARY

(71) Applicant: Brian Culwell, Spring, TX (US)

(72) Inventor: Brian Culwell, Spring, TX (US)

(21) Appl. No.: 14/843,470

(22) Filed: Sep. 2, 2015

Related U.S. Application Data
(60) Provisional application No. 62/045,610, filed on Sep. 4, 2014.

(51) Int. Cl. G06Q 20/38; G06Q 20/34; G06Q 20/02

(52) U.S. Cl. CPC G06Q 20/383; G06Q 20/027; G06Q 20/342

(57) ABSTRACT

Embodiments described herein are directed towards systems and methods for anonymously paying for goods and/or services. Embodiments may enable a user to complete an online transaction for goods and/or services using a gift card, wherein the gift card may not have any information associated with the user.

### CROSS-REFERENCE TO RELATED APPLICATIONS

This application claims a benefit of priority under 35 U.S.C. §119 to Provisional Application No. 62/045,610 filed on Sep. 4, 2014, which is fully incorporated herein by reference in its entirety.

### BACKGROUND INFORMATION

1. Field of the Disclosure

Examples of the present disclosure are related to systems and methods for anonymously paying for goods and services. Specifically, embodiments are related to an intermediary utilizing a gift card with no user information associated with a first retailer to pay for goods and/or services carried by a second retailer.

2. Background

A credit card or debit card is a card issued to a user as a system of payment for goods and/or services. A credit card or debit card (“cards”) allows a user to pay for goods and/or services based on the holder's promise to pay for the goods and/or services. Cards have become a predominate method of performing transactions over the internet. When utilizing a card to perform a transaction, user information linked to the card is transmitted to a retailer. Such information may include a user's name, social security number, address, bank info, etc. Furthermore, information about the transaction is received by a bank associated with the card. Such information may include credit card numbers, amount of purchase, retailer identification information, etc.

However, identity and account theft and mismanagement has become prevalent when performing online transactions. Accordingly, users find themselves facing a growing number of concerns when participating in online transactions using cards.

Accordingly, needs exist for more efficient and effective systems and methods to anonymously paying for goods and/or services.

### SUMMARY

Embodiments described herein are directed towards systems and methods for anonymously paying for goods and/or services. Embodiments may enable a user to complete an online transaction for goods and/or services using a gift card or other method of payment, wherein the gift card or other method of payment may not have any information associated with the user. The gift card used by the user to complete an online transaction may relate to any restricted monetary equivalent that is associated with a retailer, such as a gift card, card including a monetary equivalent associated with a retailer or a plurality of retailers, discount cards, prepaid card, stored value card, etc. (referred to hereinafter individually and collectively as “gift card”).

Embodiments may include a transaction server. The transaction server may be configured to receive a gift card associated with a first retailer, receive a selection of goods and/or services by the user to be purchased from a second retailer, purchase the selected good and/or services from the second retailer, and deliver the purchased goods and/or services to the user.

The transaction server may be configured to purchase the goods and/or services from the second retailer without transmitting any information about the user to the second retailer. Additionally, the transaction server may be configured to deliver the goods and/or services to the user without transmitting any information about the transaction to the user, or information being directly communicated between the user and the second retailer.

The transaction server may include a gift card hardware processor, a profile hardware processor, a selection hardware processor, a payment hardware processor, and a delivery hardware processor.

The gift card hardware processor may be configured to receive gift card information associated with a first retailer from the user. The gift card information may include information associated with the gift card, such as a gift card number, expiration date, security code, monetary amount associated with the gift card. However, the gift card may not include any user information, such as a user's name, address, social security number, phone number, banking information etc.

The profile hardware processor may be configured to generate a profile associated with the user. The profile may be utilized to deliver goods and/or services purchased by the user, wherein information associated with the profile may be transmitted to be stored within cache memory within a client computing device. The profile may include a user's name, a first unique identifier, address, email address, phone number, etc. The first unique identifier may be generated responsive to receiving gift card information from the user and may an expiration time period.

The selection hardware processor may be utilized by the user to purchase goods and/or services from a second retailer. The selection may be completed via the user preforming actions to select the desired goods and/or services.

The payment hardware processor may be utilized to pay for the selected goods and/or services. The payment for the goods and/or services may be completed via a credit card, debit card, or other method of payment that is associated with the transaction server, wherein the method of payment associated with the transaction server is not linked to the user. Responsive to using the method of payment associated with the transaction server to purchase the selected goods and/or services, the payment hardware processor may receive information associated with the transaction. For example, the payment hardware processor may receive information associated with the credit card number used to complete the transaction, monetary amount associated with the transaction, second retailer identification information, etc. The payment processor may insert metadata associated with the information associated with the transaction, wherein the metadata include a second unique identifier. In embodiments, the second unique identifier may be associated with the first unique identifier, wherein the second unique identifier may be linked with the first unique identifier.

The delivery hardware processor may be configured to transmit delivery information to the user indicating that the transaction has been completed. The delivery information may include a login name, password, domain name, estimated arrival date, the second unique identifier, etc. associated with the purchased goods and/or service. However, the delivery information may not include any payment information associated with the second retailer, such as purchase price, name of second retailer, etc. Responsive to receiving the second unique identifier, the first unique identifier may be removed from the cache of the client computing device. Additionally, the first unique identifier may be removed from the cache of the client computing device responsive to the expiration time period lapsing.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present embodiments are described with reference to the following figures, wherein like reference numerals refer to like parts throughout the various views unless otherwise specified.

FIG. 1 depicts one topology for anonymously paying for goods and/or services, according to an embodiment.

FIG. 2 depicts one embodiment of a transaction server.

FIG. 3 illustrates a method for anonymously purchasing goods and/or services over the internet.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Embodiments described herein are directed towards systems and methods for anonymously paying for goods and/or services. Embodiments may enable a user to complete an online transaction for goods and/or services using a gift card, wherein the gift card may not have any information associated with the user.

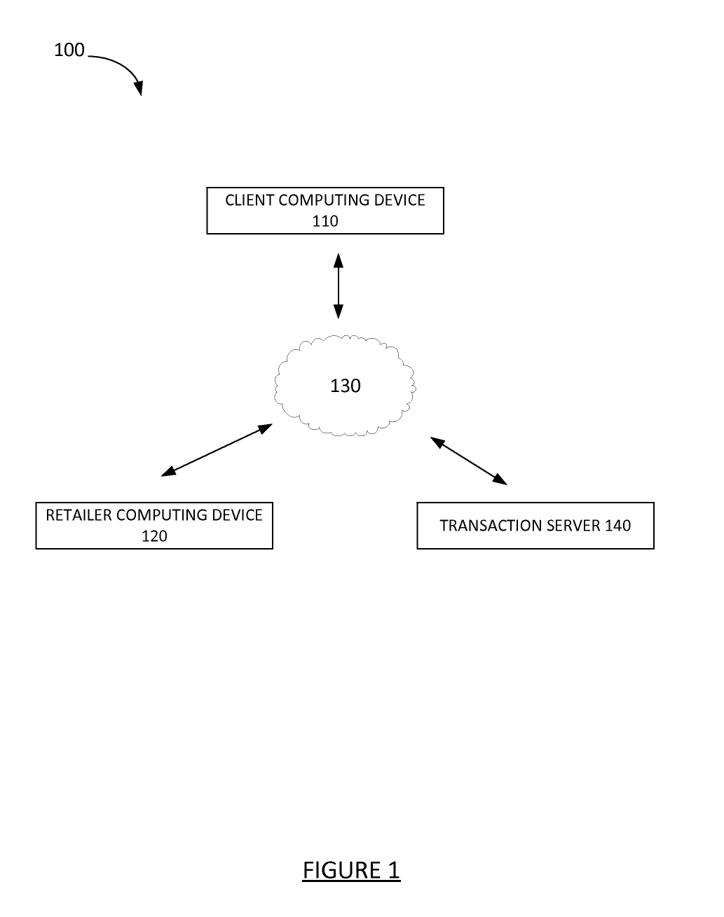

Turning now to FIG. 1, FIG. 1 depicts one topology 100 for anonymously paying for goods and/or services. Topology 100 may include a client computing device 110, retailer computing device 120, and transaction server 140. The elements depicted in topology 100 may be communicatively coupled to each other over network 130. In other embodiments, elements depicts in topology within a first device (i.e. transaction server 140) may be located in a second device (i.e. first client computing device 110 or retailer computing device 120). Accordingly, FIG. 1 is a non-limiting network topology 100 for determining balances associated with outstanding gift cards.

Network 130 may be a wired or wireless network such as the Internet, an intranet, a LAN, a WAN, a cellular network or another type of network. It will be understood that network 130 may be a combination of multiple different kinds of wired or wireless networks. Network 130 may also be comprised of telephone lines, fiber optic cables, internet cables, microwave transmission links, cellular networks, communications satellites, undersea telephone cables, which may be interconnected by switching centers. The switching centers associated with network 130 may allow any telephone or device with a processor to simulate a telephone to communicate with each other. It will be understood that network 130 may be a combination of multiple different kinds of wired or wireless networks, which may include analog telephone systems and/or digital telephone systems.

Client computing device 110 may be a laptop computer, desktop computer, smart phone, tablet computer, personal data assistant, or any other type of device with a hardware processor that is configured to process instructions and connect to network 130 and/or other forms of networks. Client computing device 110 may include a user interface, a communication device, and a memory device.

The user interface may be a touch screen, a physical keyboard, a mouse, a camera, scale, barcode scanner, a video camera, a microphone, etc. configured to receive inputs associated with a user's actions. For example, the user may use the interface to generate a user profile, select and purchase a product and/or service offered by a retailer, purchase a gift card, enter information associated with the gift card.

The communication device may be configured to receive data generated by client computing device via the user interface, and transmit data generated via the user interface to other elements over network 130. The memory device may be a device that is configured to store data received from transaction server 140.

The memory device may include, but is not limited to cache memory, a hard disc drive, an optical disc drive, and/or a flash memory drive. For example, memory device may store login and/or password information associated with a good and/or service offered by a retailer.

For example, responsive to a user performing actions on the user interface to select goods and/or services to be purchased from client a retailer, the communication device may receive a first unique identifier from transaction server 140, wherein the first unique identifier may be stored in cache memory of the memory device and have an expiration period. When the goods and/or services are purchased without using direct communications between client computing device 110 and retailer computing device 120, the communication device may receive a second unique identifier, wherein the second unique identifier may be a secure token associated with the first unique identifier. Responsive to the second unique identifier being received from transaction server 140, a hardware processing device associated with client computing device 110 may remove the first unique identifier from the cache memory. In further embodiments, responsive to receiving the second unique identifier the information associated with the gift card utilized to purchase the goods and/or services may also be deleted. Accordingly, information transmitted between the client computing device 110 and the transaction server 140 may be limited, which may result in more secure transactions to purchase goods. Furthermore, by not having direct communication between client computing device 110 and retailer computing device 120, if the retailer's computing systems become compromised, information associated with the user will not be compromised.

Retailer computing device 120 may be a laptop computer, desktop computer, smart phone, tablet computer, personal data assistant, or any other type of device with a hardware processor that is configured to process instructions and connect to network 130 and/or other forms of networks. Retailer computing device 120 may be associated with a retailer, store, service provider, etc. (referred to hereinafter individual and collectively as “retailer”). The retailer may offer to sells goods and/or services to a user of client computing device 110 over network 130. For example, retailer computing device 120 may be associated with a website that sells subscriptions to access content, such as ESPN insider, New York Times, Amazon Prime, etc. In other embodiments, retailer computing device 120 may be associated with a retailer selling goods over network 130, such as STEAM video games, iTunes, etc.

Transaction server 140 may be a computing device, such as a general hardware platform server configured to support mobile applications, point of sale (POS) devices, software, and the like executed on client computing device 110 and/or retailer computing device 120. Transaction server 140 may include physical computing devices residing at a particular location or may be deployed in a cloud computing network environment. In this description, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Transaction server 140 may include any combination of one or more computer-usable or computer-readable media. For example, transaction server 140 may include a computer-readable medium including one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device.

Transaction server 140 may also be configured to allocate and provision computing resources based on a processing load on transaction server 140. The processing load may be associated with a number of users simultaneously desiring to anonymously process transactions, security features being enabled, create user profiles, etc. Transaction server 140 may be configured to balance a processing load by distributing workloads across multiple computing resources, wherein transaction server 140 may dynamically balance the load using services offered by various hardware devices across network 130. By provisioning load balances associated with different hardware computing devices across network 130, transaction server 140 may increase the speed of processing transactions, while also lowering costs associated with anonymously processing the transactions. In embodiments, transaction server 140 may be configured to scale up and/or down based on the processing load by efficiently and dynamically allocating the processing load across nodes evenly.

In embodiments, transaction server 140 may be configured to receive a gift card associated with a first retailer from client computing device 110, and a selection of goods and/or services to be purchased for the user from a second retailer, wherein the first gift card associated with the first retailer is not associated with the second retailer. Responsive to receiving the gift card associated with the first retailer, transaction server 140 may determine if the monetary amount associated with the gift card is sufficient to purchase the goods and/or services carried by the second retailer.

If the monetary amount is sufficient, transaction server 140 may utilize an intermediary method of payment to purchase the goods and/or services from the second retailer without transmitting any information about the user to the second retailer, wherein the intermediary method of payment is independent from the user and/or the gift card. Responsive to purchasing the goods and/or services via the intermediary method of payment, transaction server 140 may receive transaction details associated with the purchased good and/or services. Furthermore, transaction server 140 may deliver or transmit the purchased goods and/or services from the second retailer to client computing device 110 without transmitting any information about the transaction to the user.

Accordingly, transaction server 140 may be utilized by a user of client computing device 110 to purchase and receive goods and/or services from a retailer associated with retailer computing device 140, wherein the user does not submit any information associated with the user to retailer computing device 140, and the user does not receive any banking information associated with the transaction.

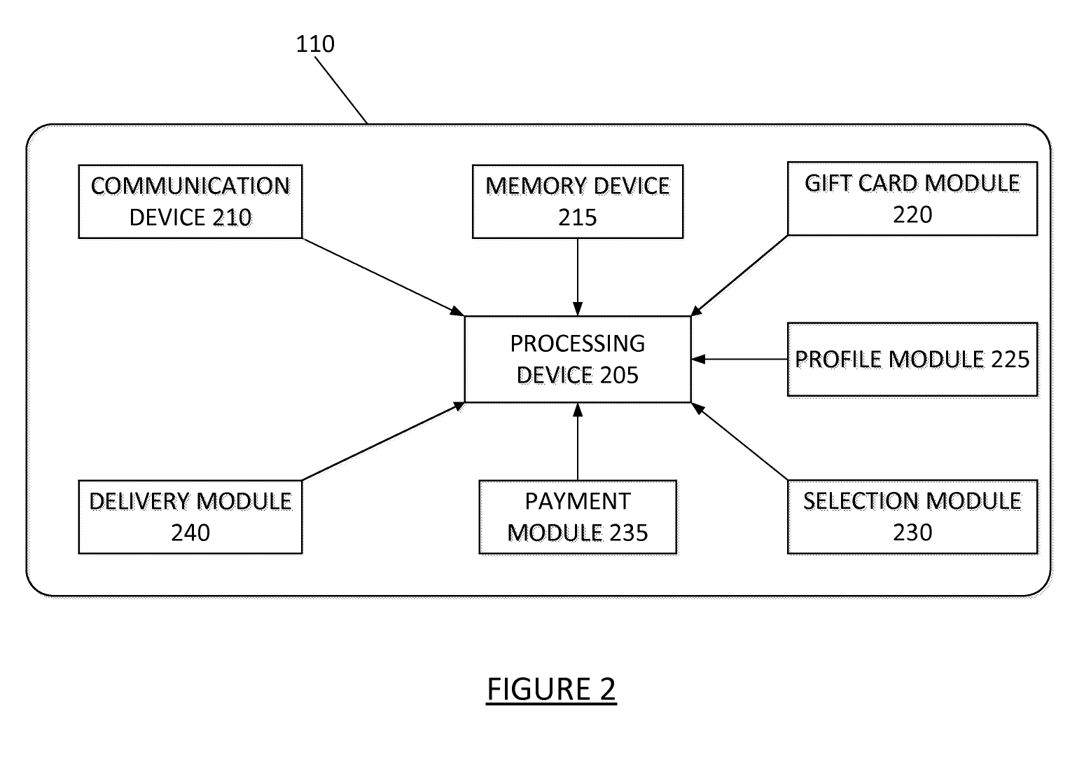

FIG. 2 depicts one embodiment of transaction server 140. Transaction server 140 may include a processing device 205, communication device 210, memory device 215, gift card hardware processor 220, profile hardware processor 225, selection hardware processor 230, payment hardware processor 235, and delivery hardware processor 240.

Processing device 205 may include memory, e.g., read only memory (ROM) and random access memory (RAM), storing processor-executable instructions and one or more processors that execute the processor-executable instructions. In embodiments where processing device 205 includes two or more processors, the processors may operate in a parallel or distributed manner. Processing device 205 may execute an operating system of transaction server 140 or software associated with other elements of transaction server 140.

Communication device 210 may be a device that allows transaction server 140 to communicate with another device over network 130. Communication device 210 may include one or more wireless transceivers for performing wireless communication and/or one or more communication ports for performing wired communication over the internet, PSTN, etc. Communication device 210 may be configured to communicate data over a plurality of different standard and/or protocols.

Memory device 215 may be a device that stores data generated or received by transaction server 140. Memory device 215 may include, but is not limited to a hard disc drive, an optical disc drive, and/or a flash memory drive. In embodiments, memory device 215 may be configured to store information received from a client computing device 110 and/or retailer computing device 120. The information stored within memory device 215 may be accessed by processing device 205, communication device 210, and/or hardware processors 220, 225, 230, 235, 240.

Gift card hardware processor 220 may be a device configured to sell a gift card to a user of client computing device 110 and/or determine an existing balance associated with a gift card owned by the user of client computing device 110. In embodiments, the gift card sold or owned by the user may be associated with a first retailer. The gift card may include gift card information and a balance. The gift card information may include retailer information, identification number, protection code, contact information, expiration date, etc. The balance may be associated with a monetary value that the user may spend at the first retailer. However, the gift card may not include any user information, such as a user's name, address, social security number, phone number, banking information etc.

Profile hardware processor 225 may be a device configured to allow the user of client computing device 110 to generate and create a user profile. The user's profile may include information stored in memory device 215 and/or other storage locations. The user's profile may include user information and balance information. The user information may include contact information associated with the user, such as, information identifying users (e.g., a username or handle, a number, an identifier, and/or other identifying information), security login information (e.g., a login code or password), gift card information, a phone number associated with the user, an email address associated with the user, a mailing address associated with the user, etc. The balance information may include a metric associated with the balances on the gift cards determined by gift card hardware processor 220. The metric may be associated with the balance of the gift cards, expiration date of the gift cards, type of first retailer, etc. The metric may be an aggregate metric for a plurality of gift cards. For example, the aggregate metric may be a number based on the balance of a first gift card and the balance of the second gift card. In embodiments, responsive to receiving information associated with a first retailer from a user, profile hardware processor 225 may transmit a first unique identifier to be stored in cache memory of a client computing device, wherein the first unique identifier may have an expiration time period. The first unique identifier may be utilized to link the first gift card with the user's profile on profile hardware processor 225. In embodiments, the first unique identifier may be an IP address, MAC address, random generated number, login name, etc.

Selection hardware processor 230 may be a device configured to allow the user to select a good and/or service carried by a second retailer to be purchased, wherein the goods and/or services carried by the second retailer may include an associated price. In embodiments, the first retailer and the second retailer may be different retailers. Selection hardware processor 230 may include a pull down menu, wherein the user may select a desired good and/or service from a list. For example, selection hardware processor 230 may allow the user to select a subscription and a desired a length of time for an online sports website (e.g. ESPN insider for 3 months) for a first price. In other embodiments, selection hardware processor 230 may allow the user to free form type the desired good and/or service. For example, in selection hardware processor 230 may include a word processor allowing a user to type “ESPN insider for 3 months.” Based on the free form typing, an agent of transaction server 140 may determine the desired good and/or service and associated prices.

Payment hardware processor 235 may be a device configured to pay for the selected goods and/or services. Payment hardware processor 235 may be configured to pay for the goods and/or services via a credit card, debit card, or other method of payment that is associated with transaction server 140. In embodiments, the method of payment associated with transaction server 140 is not linked to the user. Payment hardware processor 235 may be configured to determine if the metric indicating the balance of gift cards associated with the user is sufficient to purchase the selected goods and/or services.

Responsive to determining that the metric associated with the user's gift cards is sufficient to purchase the selected good and/or services, payment hardware processor 235 may utilize the transaction server 140 method of payment to purchase the selected goods and/or services. Accordingly, by transaction server 140 utilizing a method of payment that is unassociated with the user, payment hardware processor 235 may receive transaction and banking information associated with the purchase. For example, payment hardware processor 235 may receive information associated with the credit card number used to complete the transaction, monetary amount associated with the transaction, second retailer identification information, etc.

In further embodiments, to pay for goods and/or services associated with the second retailer for a user over network 130, payment hardware processor 235 may automatically populate any desired fields associated a transaction with the user's profile information. For example, payment hardware processor 235 may automatically populate a login name and password within the user's profile to be the login name and password associated with the transaction.

In other embodiments, payment hardware processor 235 may populate any fields associated with the transaction with default data. The default data may not be associated with the user, such as a template login name and a set password, wherein the user does not know the default data before completing the transaction.

Delivery hardware processor 240 may be a hardware computing device configured to transmit delivery information to the user, wherein the deliver information indicates that the transaction has been completed by payment hardware processor 235. The delivery information may include a login name, password, estimated arrival date, etc. associated with the purchased goods and/or service. In embodiments, the delivery information may include the default data, which may be randomly generated by transaction server 140.

However, the delivery information may not include any payment information associated with the second retailer, such as purchase price, name of second retailer, etc. In embodiments, the delivery information may include the login name and/or password within the user's profile, or the delivery information may include a default login name and/or password that were not originally associated with the user. Accordingly, delivery hardware processor 240 may allow the user to access the goods and/or services purchased without any further information about the purchase being transmitted to the user. In embodiments, the delivery information may also include a second unique identifier that is linked to the first unique identifier. Responsive to receiving the second unique identifier, the first unique identifier may be removed from the cache of the client computing device. Additionally, the first unique identifier may be removed from the cache of the client computing device responsive to the expiration time period lapsing. Accordingly, the first unique identifier may be utilized as a token to link the gift card information stored on the client computing device with a transaction, without transaction server 140 communicating information associated with the first gift card to the client computing device. If the gift card is not utilized to complete a transaction within a given time period, the association between the first gift card and the transaction server 140 may be deleted. This may limit data being compromised.

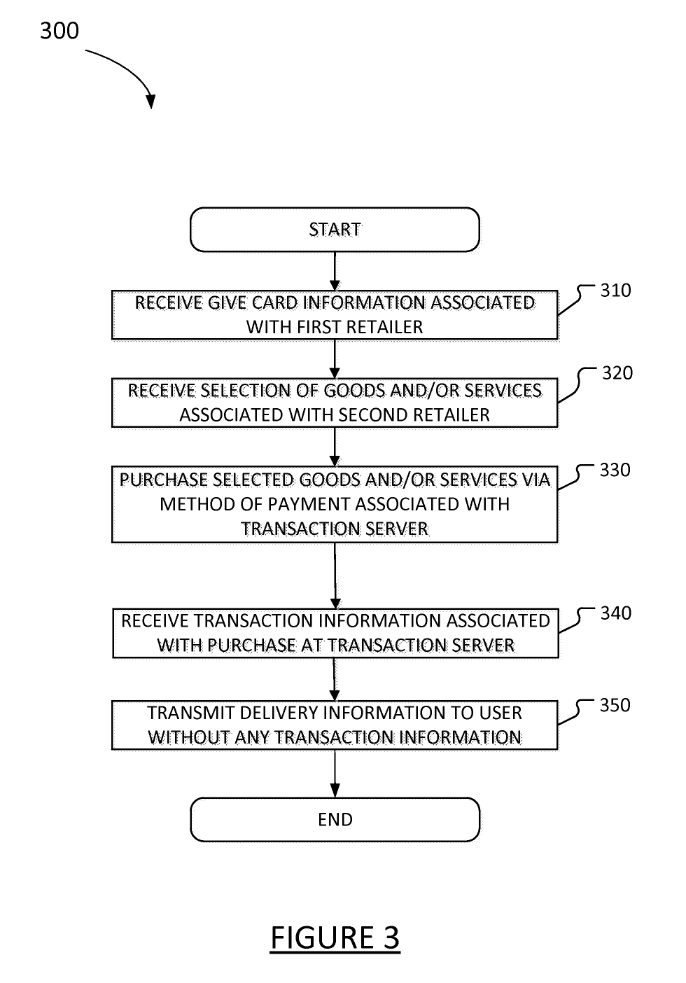

FIG. 3 illustrates a method 300 for anonymously purchasing goods and/or services over the internet. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 500.

At operation 310, information associated with a gift card for a first retailer may be received. The gift card information may include a user name, retailer information, identification number, protection code, contact information, expiration date, etc. The balance may be associated with a monetary value that the user may spend at the first retailer. However, the gift card may not include any user information, such as a user's name, address, social security number, phone number, banking information etc. Responsive to receiving the gift card information, a first unique identifier may be transmitted to a client computing device. Operation 310 may be performed by a gift card hardware processor that is the same as or similar to gift card hardware processor 220, in accordance with one or more implementations.

At operation 320, a selection for the user to purchase goods and/or services associated with a second retailer may be received. The selection may be received via a pull down menu, free form typing, selecting boxes, uploading a desired purchase using screenshots, etc. Operation 320 may be performed by a selection hardware processor that is the same as or similar to selection hardware processor 230, in accordance with one or more implementations.

At operation 330, an intermediary transaction server may utilize a method of payment (e.g. electronic money, debit card, gift card, credit card, etc.) that is unassociated with the user to purchase the selected goods and/or services. The method of payment unassociated with the user may include a name, address, banking information, contact information, etc. that is independent from the user. Operation 330 may be performed by a payment hardware processor that is the same as or similar to payment hardware processor 235, in accordance with one or more implementations.

At operation 340, transaction information associated with the purchased goods and/or services may be received by the transaction server. The transaction information may include any information linking the method of payment with the goods and/or services, such as banking information, name, contacting information, address, etc. In embodiments, none of the transaction information may be linked to the user. Operation 340 may be performed by a payment hardware processor that is the same as or similar to payment hardware processor 235, in accordance with one or more implementations.

At operation 350, delivery information may be transmitted to the user. The delivery information may include information associated with how the user may access the purchased goods and/or services. For example, the delivery information may include a login and/or password and domain name where the user may access the purchased goods and/or services. The delivery information may also include a second unique identifier; wherein responsive to the client computing device receiving the second unique identifier the first unique identifier may be deleted. Operation 350 may be performed by a delivery hardware processor that is the same as or similar to delivery hardware processor 240, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present embodiments may take the form of an entirely hardware embodiment, an entirely software embodiment (including firmware, resident software, micro-code, etc.), or an embodiment combining software and hardware aspects that may all generally be referred to herein as a “hardware processor” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

The flowcharts and block diagrams in the flow diagrams illustrate the architecture, functionality, and operation of possible implementations of systems, methods, and computer program products according to various embodiments of the present invention. In this regard, each block in the flowcharts or block diagrams may represent a hardware processor, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowcharts and/or block diagrams.

What is claimed is:

1. A system for performing secure transactions over an internet through an intermediary, the system comprising:
a client computing device configured to transmit gift card information, the gift card information being associated with a gift card for a first retailer;
a retailer computing device configured to receive a selection of a good or service over the internet, wherein the first retailer is not associated with the retailer computing device;
an intermediary computing device configured to receive the gift card information from the client computing device and transmit a selection of the selected good or service to the retailer computing device, and being configured to transmit delivery information to the client computing device including access information to access the selected good or service, wherein the client computing device does not communicate data with the retailer computing device.

2. The system of claim 1, wherein the intermediary computing device is configured to determine a metric value associated with the gift card, wherein the gift card information does not include any information about a user.

3. The system of claim 2, wherein the intermediary computing device is configured to create a profile associated with the user, wherein the profile associated with the user is linked to the metric value associated with the gift card.

4. The system of claim 3, wherein the intermediary computing device is configured automatically populate fields associated with the transaction responsive to receiving the selection of the selected goods or service.

5. The system of claim 1, wherein the intermediary computing device includes an intermediary payment system that is not associated with the user.

6. The system of claim 5, wherein the intermediary computing device is configured to remit payment for the selected good or service from the retailer computing device using the intermediary payment system.

7. The system of claim 6, wherein the intermediary computing device receives transaction information from the retailer computing device responsive to remitting payment for the selected good or service.

8. The system of claim 1, wherein responsive to the intermediary computing device receiving the gift card information, the intermediary computing device transmits a first unique identifier to the client computing device, wherein the first unique identifier is stored in cache memory of the client computing device.

9. The system of claim 8, wherein the delivery information includes a second unique identifier.

10. The system of claim 9, wherein responsive to receiving the second unique identifier, the first unique identifier may be removed from the cache of the client computing device.

11. A method for performing secure transactions over an internet through an intermediary, the system comprising:
transmitting, via a client computing device, gift card information, the gift card information being associated with a gift card for a first retailer;
receiving, via a retailer computing device, a selected good or service over the internet, wherein the first retailer is not associated with the retailer computing device;
receiving, via an intermediary computing device, the gift card information from the client computing device;
transmitting, via the intermediary computing device, a selection of the selected good or service to the retailer computing device; and
transmitting, via the intermediary computing device, delivery information to the client computing device including access information to access the selected good or service, wherein the client computing device does not communicate data with the retailer computing device.

12. The method of claim 11, further comprising:
determining a metric value associated with the gift card, wherein the gift card information does not include any information about a user.

13. The method of claim 12, further comprising:
creating a profile associated with the user, wherein the profile associated with the user is linked to the metric value associated with the gift card.

14. The method of claim 13, further comprising:
automatically populating fields associated with the transaction responsive to receiving the selection of the selected goods or service.

15. The method of claim 11, wherein the intermediary computing device includes an intermediary payment system that is not associated with the user.

16. The method of claim 15, further comprising:
remitting payment for the selected good or service from the retailer computing device using the intermediary payment system.

17. The method of claim 16, further comprising:
receiving, at the intermediary computing device, transaction information from the retailer computing device responsive to remitting payment for the selected good or service.

18. The method of claim 11, wherein responsive to the intermediary computing device receiving the gift card information, the intermediary computing device transmits a first unique identifier to the client computing device, wherein the first unique identifier is stored in cache memory of the client computing device.

19. The method of claim 18, wherein the delivery information includes a second unique identifier.

20. The method of claim 19, wherein responsive to receiving the second unique identifier, the first unique identifier may be removed from the cache of the client computing device.
